(19) United States
(12) Patent Application Publication
(10) Pub. No.: US 2009/0244075 A1
(43) Pub. Date: Oct. 1, 2009

(54) BROWSING TERMINAL

(75) Inventor: Mariko (Doi) SEKI, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 12/413,497

(22) Filed: Mar. 27, 2009

(30) Foreign Application Priority Data
Mar. 27, 2008 (JP) 2008-082838
Mar. 10, 2009 (JP) 2009-055927

(51) Int. Cl. G09G 5/36; G06F 17/00; G09G 5/00

(52) U.S. Cl. 345/530; 707/104.1; 707/E17.001; 345/211; 345/581

(57) ABSTRACT

A browsing terminal includes a nonvolatile display unit and a reminder data storing unit. The nonvolatile display unit overwritably displays a first display image based on first display data when the nonvolatile display unit is set to a first mode. The nonvolatile display unit maintains the first display image when the nonvolatile display unit is set to a second mode. The reminder data storing unit stores reminder data. The remainder data includes information about the first display image. The nonvolatile display unit displays a remainder image based on the reminder data ahead of the first display image when the nonvolatile display unit is set to the first mode after the nonvolatile display unit was set to the second mode.

### CROSS REFERENCE TO RELATED APPLICATION

This application claims priority from Japanese Patent Application No. 2008-082838 filed Mar. 27, 2008 and Japanese Patent Application No. 2009-055927 filed Mar. 10, 2009. The entire content of each of these priority applications is incorporated herein by reference.

### TECHNICAL FIELD

The present invention relates to a browsing terminal, a data processing method, and a computer-readable recording medium. Specifically, the browsing terminal includes a nonvolatile display unit that overwrites display image when a drive voltage is supplied thereto and maintains the display image even if the drive voltage is interrupted.

### BACKGROUND

Japanese unexamined patent application publication no. 2007-187927 discloses a browsing terminal provided with a nonvolatile display unit. The display image on the display unit can be over-written while a drive voltage is supplied thereto, and the nonvolatile display unit is capable of preserving displayed content when the power supply to the display unit is interrupted. Hence, while a drive voltage is required for changing the display image displayed on the display screen of the nonvolatile display unit, a drive voltage is not necessary to preserve the display data. Accordingly, the display unit can preserve the displayed content without consuming power, even when the drive voltage supply to the display unit is cut off.

However, when display data is preserved on a nonvolatile display unit for along period of time without a drive voltage being supplied, the user may forget what data is displayed on the browsing terminal. The user may forget the reason for browsing the display image and forget the type of data the user was browsing relative to the image displayed currently. For example, when the browsing terminal is used as an electronic book, the user may forget previous browsing details, such as the title of the book being browsed, the number of pages in the book, or the name and number of the current chapter. Further, when reading a newspaper, the user may forget details of the newspaper that the user had been reading, such as the name of the newspaper, the page of the newspaper, and the section, such as the financial or sports section.

### SUMMARY

In view of the foregoing, it is an object of the present invention to provide a browsing terminal having a nonvolatile display unit for preserving display data even when the supply of a drive voltage is interrupted and capable of displaying data for reminding the user of information related to the content displayed on the nonvolatile display unit.

In order to attain the above and other objects, the invention provides a browsing terminal including a nonvolatile display unit and a reminder data storing unit. The nonvolatile display unit overwritably displays a first display image based on first display data when the nonvolatile display unit is set to a first mode. The nonvolatile display unit maintains the first display image when the nonvolatile display unit is set to a second mode. The reminder data storing unit stores reminder data. The remainder data includes information about the first display image. The nonvolatile display unit displays a remainder image based on the reminder data ahead of the first display image when the nonvolatile display unit is set to the first mode after the nonvolatile display unit was set to the second mode.

According to another aspect, the present invention provides a data processing method executed by the browsing terminal. The browsing terminal includes a nonvolatile display unit. The nonvolatile display unit overwritably displays the first display image based when the nonvolatile display unit is set to a first mode, and maintains the first display image the first display image when the nonvolatile display unit is set to a second mode. The data processing method comprising: setting the nonvolatile display unit to the first mode; storing a remainder data including information about the first display image; displaying a remainder image based on reminder data, the remainder data including information about the first display image; and displaying the first display image.

According to another aspect, the present invention provides a computer-readable recording medium that stores a data processing program executed by the browsing terminal. The browsing terminal includes a nonvolatile display unit. The nonvolatile display unit overwritably displays the first display image based when the nonvolatile display unit is set to a first mode, and maintains the first display image the first display image when the nonvolatile display unit is set to a second mode. The data processing program comprising instructions for: setting the nonvolatile display unit to the first mode; storing a remainder data including information about the first display image; displaying a remainder image based on reminder data, the remainder data including information about the first display image; and displaying the first display image.

### BRIEF DESCRIPTION OF THE DRAWINGS

The particular features and advantages of the invention as well as other objects will become apparent from the following description taken in connection with the accompanying drawings, in which:

FIG. 1 is a perspective view of a browsing terminal according to a first embodiment in the present invention;

FIG. 2 is a front view of a nonvolatile display unit provided in the browsing terminal;

FIG. 3 is a cross-sectional view of the nonvolatile display unit along the plane A-A′ shown in FIG. 2;

FIG. 4 is a cross-sectional view of the nonvolatile display unit along the plane B-B′ shown in FIG. 2;

FIG. 5 is a block diagram showing the electrical structure of the browsing terminal;

FIG. 6 is a conceptual diagram illustrating an example of display data is managed as files in a plurality of folders arranged in a hierarchical structure;

FIG. 7 is a table showing an example of the configuration of operation history data;

FIG. 8 is a table showing an example of the configuration of both display data file and current display page data;

FIG. 9 is a flowchart illustrating steps in a main process according to the first embodiment;

FIG. 10 is a flowchart illustrating steps in a key operation event process according to the first embodiment;

FIG. 11 is a flowchart illustrating steps in a reminder data display process according to the first embodiment;

FIG. 12 is an explanatory diagram showing an example of changing display images by the nonvolatile display unit;

FIG. 13 is a flowchart illustrating steps in the reminder data display process according to a first variation of the first embodiment;

FIG. 14 is a flowchart illustrating steps in the reminder data display process according to a second variation of the first embodiment;

FIG. 15 is a table showing an example of display time and number of hierarchical position;

FIG. 16 is an explanatory diagram showing an example of a reminder image;

FIG. 17 is an explanatory diagram showing another example of a reminder image;

FIG. 18 is an explanatory diagram showing yet another example of a reminder image;

FIG. 19 is a flowchart illustrating steps in a reminder data display process according to a second embodiment;

FIG. 20 is a table showing an example of display time and numbers of operation history records;

FIG. 21 is an explanatory diagram showing an example of first display image and reminder images during the second embodiment;

FIG. 22 is a flowchart illustrating steps in the reminder data display process according to a first variation of the second embodiment;

FIG. 23 is an explanatory diagram showing an example of first display image and reminder images;

FIG. 24 is a flowchart illustrating steps in a reminder data display process according to a third embodiment;

FIG. 25 is a table showing an example of display time and number of page;

FIG. 26 is an explanatory diagram showing another example of first display image and reminder image;

FIG. 27 is an explanatory diagram showing another example of reminder images; and

FIG. 28 is an explanatory diagram showing an example of first display image and reminder images that are displayed in the reminder data display process according to the first variation of the first embodiment.

### DETAILED DESCRIPTION

A browsing terminal according to embodiments and variations of the invention will be described while referring to the accompanying drawings wherein like parts and components are designated by the same reference numerals to avoid duplicating description.

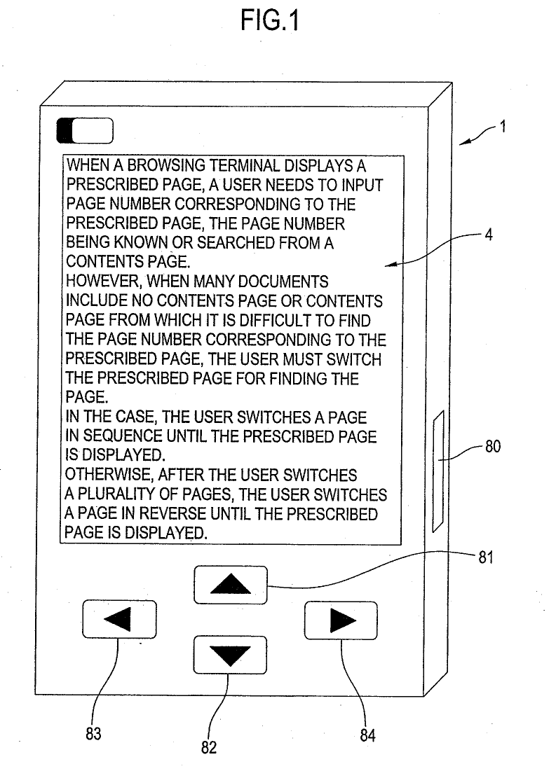

First, a first embodiment applying the present invention to a browsing terminal will be described while referring to the FIGS. 1 through 12.

FIG. 1 shows the external structure and appearance of the browsing terminal according to the first embodiment. A browsing terminal 1 according to the first embodiment has a substantially rectangular parallelepiped shaped frame. An electrophoretic display unit 4 is provided on the front surface of the browsing terminal 1 for displaying content. The electrophoretic display unit 4 overwritably displays a display image based on display data when the electrophoretic display unit 4 is set to an operation mode. The operation mode is set when a supply drive is supplied to the electrophoretic display unit 4. The electrophoretic display unit 4 maintains the display image when the nonvolatile display unit is set to an interruption mode. The interruption mode is set when the drive voltage halts to supply electrophoretic display unit 4.

Four operating keys 81-84 are provided on the lower front surface of the browsing terminal 1. A card slot 80 for inserting a memory card is provided in the side surface of the browsing terminal 1.

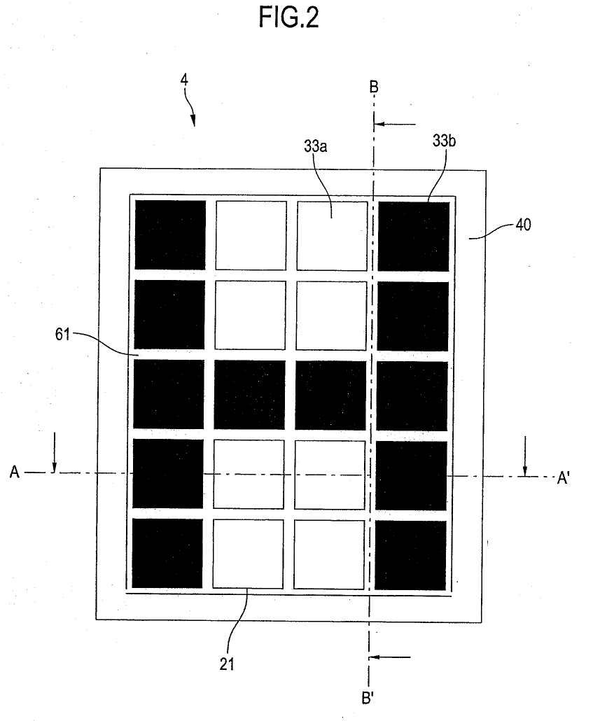

Here, the electrophoretic display unit 4 will be described with reference to FIGS. 2 through 4. For the sake of description, the electrophoretic display unit 4 described in FIGS. 2 through 4 has 5×4=20 pixels, though the number of pixels may be modified according to need.

As shown in FIG. 2, twenty pixels 21 are provided on a display surface of the electrophoretic display unit 4 for displaying content of display image. Electrodes (not shown) are provided at the same positions as the pixels 21 for applying an electric field to the pixels 21. An upper electrode protective film 61 covers the peripheral regions of the pixels 21. The upper electrode protective film 61 is formed of a material exhibiting high transparency, such as polyimide, polyethylene terephthalate, or glass. A mask 40 covers the peripheral edge of the electrophoretic display unit 4 where the pixels 21 are not provided in order to conceal this region from the user.

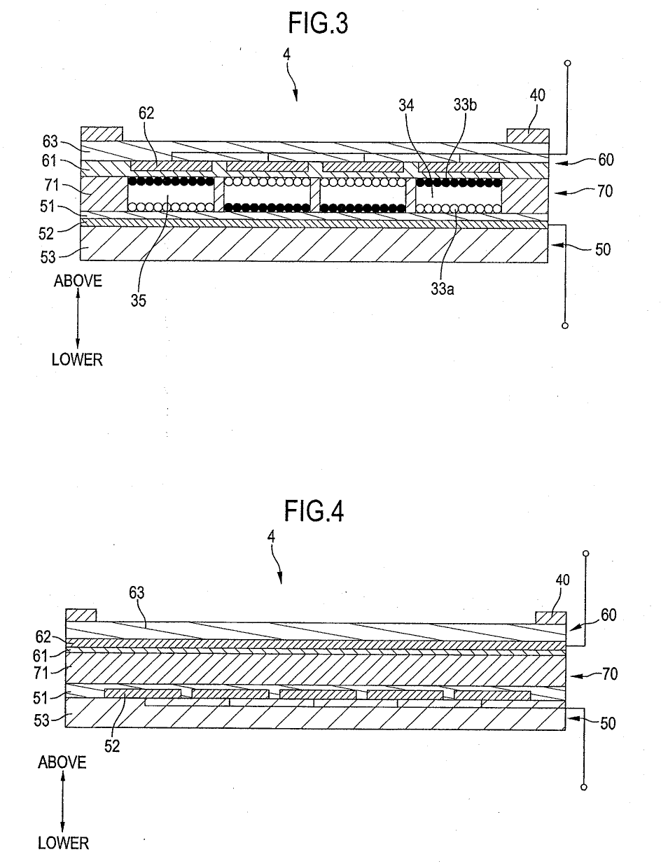

In the following description, the direction of the arrows shown in FIGS. 3 and 4 will be referred to as above and lower directions in the drawings. As shown in FIGS. 3 and 4, the electrophoretic display unit 4 is provided with the mask 40, a lower substrate 50, an upper substrate 60, a display section 70, and a spacer 71. The lower substrate 50 is provided in a lower surface section of the electrophoretic display unit 4. The upper substrate 60 is disposed at a position opposing the top of the lower substrate 50 through the display section 70. The display section 70 is interposed between the lower substrate 50 and the upper substrate 60.

The display section 70 includes a spacer 71. The spacer 71 is disposed between the lower substrate 50 and upper substrate 60 and has a lattice shape that divides the area above the lower substrate 50 uniformly into a plurality of pixel spaces 35. The spacer 71 is supported between the lower substrate 50 and upper substrate 60 and is formed of a flexible plate-shaped material, such as polyimide, polyethylene terephthalate, or another synthetic resin. In the first embodiment, the spacer 71 is formed of polyethylene terephthalate.

The display section 70 is configured of the pixel spaces 35, each of which holds charged particles 33a, charged particles 33b, and a dispersion medium 34. More specifically, a plurality of charged particles 33a, a plurality of charged particles 33b, and the dispersion medium 34 are provided in each of the plurality of pixel spaces 35 formed above the lower substrate 50 by the lattice-shaped spacer 71. One pixel 21 is formed by each pixel space 35 filled with the charged particles 33a, charged particles 33b, and dispersion medium 34. The charged particles 33a and charged particles 33b are formed of a material that can be charged in the dispersion medium 34, such as pigments and dyes formed of organic or inorganic compounds, or pigments and dyes encapsulated in synthetic resin. In the first embodiment, the charged particles 33a are formed of a mixture of styrene resin and titanium dioxide. The charged particles 33a have an average particle size of 5 μm (7 wt %), while the amount of titanium dioxide in the particles is 40 wt %. The charged particles 33b are formed of a mixture of styrene resin and carbon black and have an average practical size of 5 μm (10 wt %), with an amount of carbon black in the particles of 30 wt %. Therefore, the charged particles 33a have a white color tone, while the charged particles 33b have a black color tone. Further, the charged particles 33a have an opposite charge to that of the charged particles 33b. In the first embodiment, the charged particles 33a are given a negative charge, while the charged particles 33b are given a positive charge.

The dispersion medium 34 is an alcohol, a hydrocarbon, or silicone oil having a high insulating property and low viscosity. In the first embodiment, Isopar (73 wt %), a paraffinic solvent manufactured by Exxon Mobil, is used as the dispersion medium 34. Ethanol (10 wt %) is introduced into the dispersion medium 34 as an additive.

The lower substrate 50 is provided with a lower electrode protective film 51, a lower electrode 52, and a support unit 53. The lower electrode protective film 51 is an insulating film formed by applying an insulating material to the top surface of the lower electrode 52. The lower electrode protective film 51 is formed of an inorganic material or other material having a high insulating effect, such as polyethylene terephthalate, silica, or another resin film, or glass. In the first embodiment, the lower electrode protective film 51 is formed of polyethylene terephthalate.

The lower electrode 52 functions to apply a voltage to the pixels 21. The lower electrode 52 is configured of a common electrical conductor provided with a plurality of electrodes for applying a constant voltage to the pixels 21.

The support unit 53 is provided on the bottom surface of the lower electrode 52 and serves to support the browsing terminal 1 itself.

The upper substrate 60 is provided with the upper electrode protective film 61, an upper electrode 62, and a display layer 63. The mask 40 is provided on the top surface of the upper substrate 60 (the surface not opposing the lower substrate 50).

The upper electrode protective film 61 is an insulating film formed by applying insulating materials to the bottom surface of the upper electrode 62, such as a polyimide, polyethylene terephthalate, glass, or other highly transparent material. In the first embodiment, the upper electrode protective film 61 is configured of a plastic substrate (resin film) formed of polyethylene terephthalate.

The upper electrode 62 functions to generate electric fields between corresponding regions of the lower electrode 52. The upper electrode 62 is disposed parallel to the lower electrode 52 for applying a constant voltage to each of the pixels 21. The upper electrode 62 is formed of a highly transparent material. In the first embodiment, transparent electrodes formed of indium tin oxide (ITO) are used as the upper electrode 62.

The display layer 63 is formed of a transparent material and is disposed on a top surface of the upper electrode 62. The display layer 63 functions as a display screen. A glass substrate is used as the display layer 63. By forming the upper substrate 60 of a highly transparent material, the user can see the display section 70 from a position above the upper substrate 60.

The mask 40 is formed of a constant width along the four sides of the upper substrate 60 for concealing from the user the peripheral region of the display section 70 in which the pixels 21 exist. A square-shaped plate member such as that shown in FIG. 2 is used as the mask 40 in order that the user can visualize the display section 70. The mask 40 is constructed by coloring a member formed of a synthetic resin, such as polyethylene terephthalate. Alternatively, a layer of ink or the like having a similar effect to the mask 40 may be applied directly to the surface of the display layer 63. Polyethylene terephthalate is used as the mask 40 in the first embodiment.

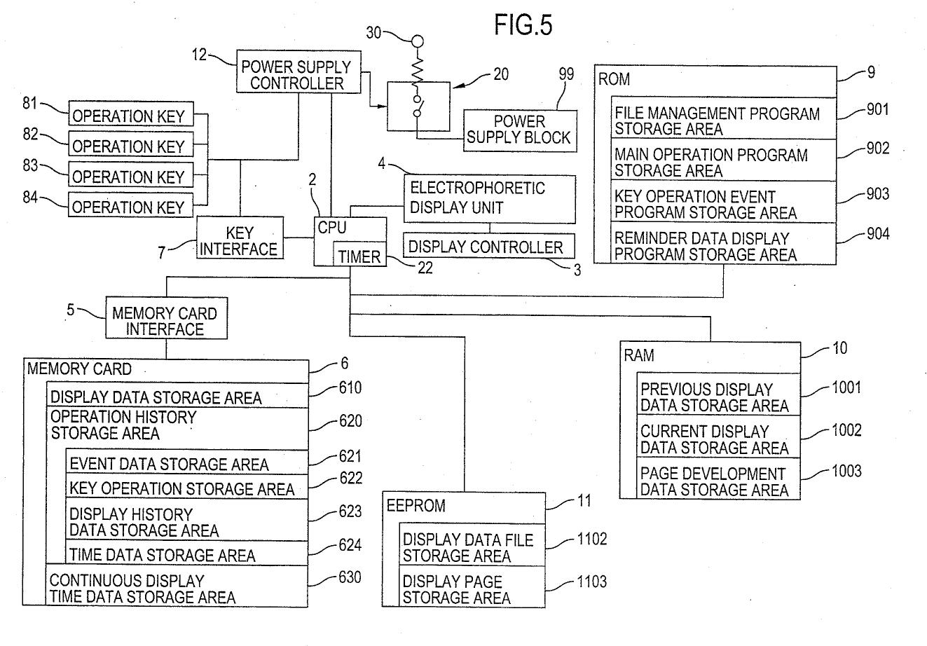

FIG. 5 is a block diagram showing the electrical structure of the browsing terminal 1 according to the first embodiment. As shown in FIG. 5, the browsing terminal 1 includes a CPU 2, a display controller 3, a memory card interface 5, a key interface 7, a ROM 9, a RAM 10, an EEPROM 11, a power supply controller 12, a system power switch, a power supply 30, operation keys 81-84, and a power supply block 99. The CPU 2 includes a timer 22 for measuring time. The CPU 2 is electrically connected to the display controller 3, the memory card interface 5, the key interface 7, the ROM, 9, the RAM 10, the EEPROM 11, and the power supply controller 12. Together with memory, including a memory card 6, the ROM 9, the RAM 10, and the EEPROM 11, the CPU 2 constitutes a computer for controlling operations of the browsing terminal 1. The key interface 7 receives input from the operating keys 81-84. In order to display data on the electrophoretic display unit 4, the display controller 3 applies a voltage between the lower electrode 52 and the upper electrode 62 based on pixel data to be displayed on the electrophoretic display unit 4.

The ROM 9 has a file management program storage area 901, a main operation program storage area 902, a key operation event program storage area 903, and a reminder data display program storage area 904. The file management program storage area 901 stores a file management program for managing display data stored in the memory card 6, which data is to be displayed on the browsing terminal 1. The file management program serves to manage the display data as files through a hierarchical structure of folders. The main operation program storage area 902 stores a main operation program for controlling the browsing terminal 1 according to the first embodiment. The key operation event program storage area 903 stores a key operation event program for switching the display image on the browsing terminal 1 in response to operations by the operating keys 81-84. The key operation event program also stores a terminal operation history in a terminal operation history storage area 620 described later for tracking the history of key operations used to switch the display image on the electrophoretic display unit 4. The reminder data display program storage area 904 stores a reminder data display program for displaying data used to remind the user of information regarding data displayed on the electrophoretic display unit 4. By displaying reminder image, the reminder data display program can remind the user about information related to the displayed image displayed currently, such as a browsing status indicating what the user has browsed thus far, and the type of data the user is browsing.

The memory card interface 5 functions to connect to the memory card 6, which is an external portable memory. The memory card 6 includes a display data storage area 610 storing display data used for displaying information on the electrophoretic display unit 4, the terminal operation history storage area 620 storing the terminal operation history of operations performed on the browsing terminal 1, and a continuous display time data storage area 630 storing continuous display time data. The continuous display time data indicates the time for displaying reminder data on the electrophoretic display unit 4. The display data storage area 610 stores the display data displaying text, images, diagrams, and the like, and coordinate data specifying positions of the display data. The coordinate data indicates the layout positions of the text, images, diagrams, and the like on the electrophoretic display unit 4.

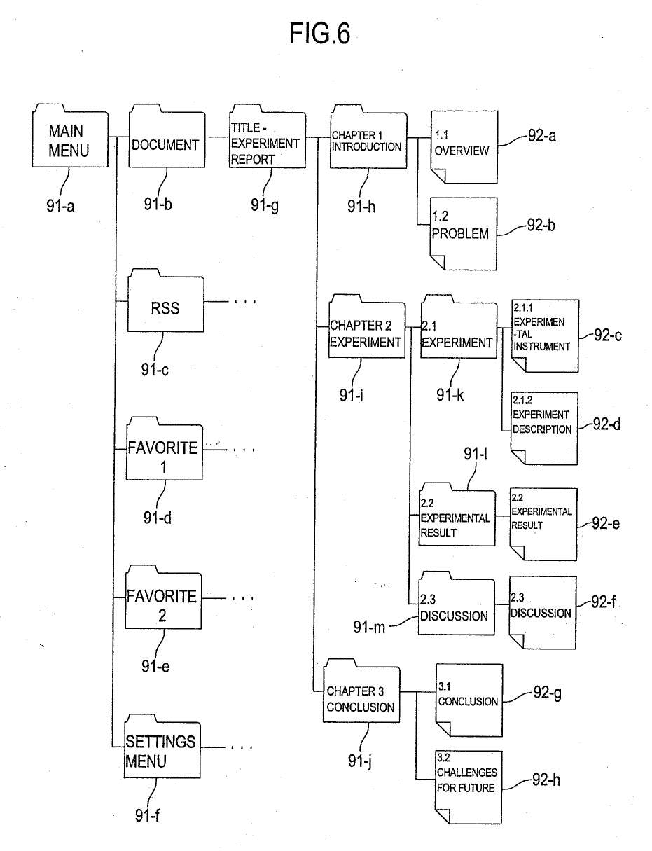

FIG. 6 is a conceptual drawing showing an example of display data stored in the display data storage area 610 managed as files in a hierarchical structure of folders. The folders and files are managed in a hierarchical structure by executing the file management program stored in the file management program storage area 901 (FIG. 5). The example in FIG. 6 shows a case in which the user is browsing an experiment report on the browsing terminal 1. In the example of FIG. 6, folders 91-a through 91-m and files 92-a through 92-h are assigned folder names and file names, and display data is managed as files in a hierarchical structure of folders. Here, the folder 91-a assigned the name “Main Menu” holds the folder 91-b assigned the name “Document” as a folder on the next lower hierarchical level. The folder 91-b holds the folder 91-g assigned the name “Title—Experiment Report” based on the title name of a book or written work. The folder 91-g holds a lower order folder 91-h assigned the name “Chapter 1—Introduction” based on the name of the first chapter. The folder 91-h holds a lower-order file 92-a assigned the name “1.1 Overview” based on the chapter name. In this way, the title name and chapter names of the book browsed on the browsing terminal 1 and chapter names are assigned as folder names and filenames in the first embodiment. The display data managed as files is configured in units of pages. Further, while the display data to be displayed on the electrophoretic display unit 4 is stored in the memory card 6 in the example described above, this data may also be stored in the EEPROM 11.

Returning to FIG. 5, the terminal operation history storage area 620 is configured of an event data storage area 621, a key operation storage area 622, a display history data storage area 623, and a time data storage area 624. The terminal operation history storage area 620 stores the new operation history data, each time event information is generated through an operation of one of the operating keys 81-84. Display changes generated in response to operations of the operating keys 81-84 and halting of power supply to the browsing terminal 1 are stored in the event data storage area 621 as event data. The key operation storage area 622 stores operation data related to operations of the operating keys 81-84 as key operation data. The display history data storage area 623 stores, as display history data, display data corresponding to display image displayed on the electrophoretic display unit 4 when the display image is switched through an operation on the operating keys 81-84. The display data is configured of a plurality of pixel data specifying either “display” (black) or “not display” (white) for each pixel of the electrophoretic display unit 4. The history data storage area 623 stores display history data including pixel data corresponding to the pixel image to be displayed on the electrophoretic display unit 4. The time data storage area 624 stores time data representing the time at which the display image was switched by an operation of the operating keys 81-84 or the time at which power supplied to the browsing terminal 1 was halted. The time data indicates a time measured by the timer 22 that has started in S102 described later.

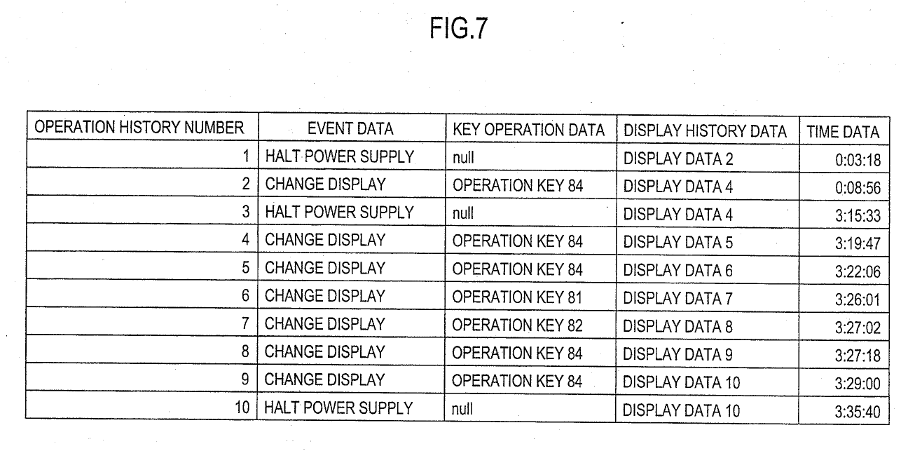

FIG. 7 is a conceptual diagram showing an example of terminal operation history stored in the terminal operation history storage area 620. In the example of FIG. 7, the terminal operation history storage area 620 stores ten records of terminal operation history. The records of operation history are assigned operation history numbers 1 through 10. History records with smallest operation history number “1” were stored earliest in the terminal operation history storage area 620. When a new record of operation history is stored, the oldest record stored in the terminal operation history storage area 620 is deleted. That is, when the new record is stored in the terminal operation history storage area 620, the CPU 2 deletes the record with the operation history number “1”, and assigns new operation history numbers “1” through “9” to remaining records that are assigned operation history numbers “2” through “10” by decreasing by 1 to “1” through “9”, and stores the new record of operation history with the operation history number “10”.

Returning to FIG. 5, the RAM 10 has a structure well known in the art, and includes a previous display data storage area 1001 that temporarily stores previous display data, a current display data storage area 1002 that temporarily stores current display data, and a page development data storage area 1003 for storing page development data. The page development data includes display data stored in the display data storage area 610, and coordinate data indicating the position on the electrophoretic display unit 4 at which the display image should be displayed.

The current display data is data corresponding to a display image that is currently displayed on the electrophoretic display unit 4. The display image will be referred to as the “current display image”. The current display data includes pixel data based on coordinate data contained in the page development data stored in the page development data storage area 1003.

The previous display data is identical to the current display data that is stored in the current display data storage area 1002 when the display image is changed in response to an operation of the operating keys 81-84 at previous time.

The EEPROM 11 preserves stored content, even when the system power supply 30 fails to supply the power. The EEPROM 11 includes a display data file storage area 1102 for storing display data file, and a current display page data storage area 1103 storing data for a currently displayed page.

The display data file storage area 1102 temporarily stores, as current display data file, filenames and folder names specifying display data corresponding to the display image to be displayed on the electrophoretic display unit 4. In other words, the display data file storage area 1102 temporarily stores, as current display data file, filename and folder names for display data stored in the display data storage area 610. The folder names are names of folders storing the current display data. The filename is the name of a file storing the current display data. In the first embodiment, filename and folder names specifying the current display data are stored in the display data file storage area 1102 as the current display data file. Based on the current display data file, the CPU 2 determines hierarchical management position by executing the file management program. The hierarchical management position is a hierarchical position of a file storing the current display data. Each set of display file data includes at least one set of page data, each set of page data assigned page number.

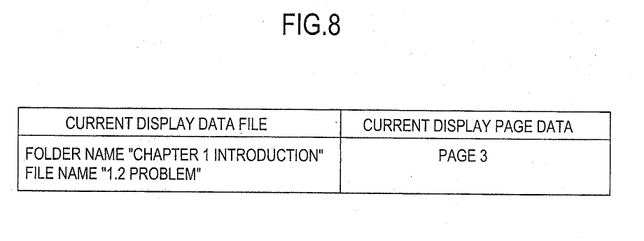

The display page data storage area 1103 stores a page number of the current display data as the current display page data. FIG. 8 is a conceptual diagram showing the state of the display data file and the current display page data stored in the EEPROM 11. The current display data file and current display page data are overwritten each time the display image is changed.

As shown in FIG. 5, the power supply controller 12 is electrically connected to the CPU 2 and the system power switch 20. One end of the system power switch 20 is electrically connected to the power supply block 99, which supplies power to each of the display controller 3, electrophoretic display unit 4, memory card interface 5, ROM 9, RAM 10, and EEPROM 11. By connecting the system power supply 30 to the power supply block 99 with the system power switch 20, it is possible to supply power from the system power supply 30 to the display controller 3, display unit 4, memory card interface 5, ROM 9, RAM 10, and EEPROM 11. The CPU 2 and power supply controller 12 receive power supplied from a different power source than the system power supply 30. With this configuration, power is supplied to the CPU 2 and power supply controller 12 even when the system power switch 20 disconnects the system power supply 30 to the power supply block 99. Therefore, the CPU 2 can receive operation signals from the operating keys 81-84 even when the system power supply 30 is not connected to the power supply block 99. The power supply controller 12 controls the system power switch 20 to interrupt the supply of power between the system power supply 30 and power supply block 99 if an operation signal has not been received from the operating keys 8′-84 for a prescribed time. The power supply controller 12 controls the system power switch 20 to connect the system power supply 30 to the power supply block 99 when an operation signal is received from the operating keys 81-84.

The display controller 3 transmits commands to the electrophoretic display unit 4 for applying voltages to the upper electrode 62 (FIG. 3) and the lower electrode 52 (FIG. 3) based on pixel data in the temporarily stored current display data. The display controller 3 transmits a command for applying a voltage of a prescribed magnitude to the lower electrode 52 and transmits commands for applying a smaller voltage than that applied to the lower electrode 52 to the upper electrode 62 for pixels specified as “display” (black). Further, the display controller 3 transmits commands for applying a larger voltage than that applied to the lower electrode 52 to the upper electrode 62 for pixels specified as “not display” (white). When a larger voltage than that applied to the lower electrode 52 is applied to the upper electrode 62, the white charged particles 33a are negatively charged and are drawn upward toward the display layer 63 shown in FIG. 3. However, when a voltage smaller than that applied to the lower electrode 52 is applied to the upper electrode 62, the black charged particles 33b are positively charged and are drawn upward toward the display layer 63 shown in FIG. 3. Images are displayed by attracting the black colored charged particles 33b to the display surface. After the display controller 3 has transmitted commands for displaying an image on the electrophoretic display unit 4, the attracted state of the charged particles 33a and charged particles 33b is sustained by the viscosity of the dispersion medium 34 and the image force, even when the power supply to the upper electrode 62 and lower electrode 52 of the electrophoretic display unit 4 is cut off. By applying electric fields in the opposite direction to the charged particles 33a and charged particles 33b, these charged particles once again move through the dispersion medium 34, reversing their positions to overwrite the image. At this time, the pixel data included in the current display data is stored in the previous display data storage area 1001 as the previous display data, and new pixel data corresponding to a next display image to be displayed next on the electrophoretic display unit 4 is stored in the current display data storage area 1002 as new current display data. Therefore, in the first embodiment, the display controller 3 transmits commands for changing the display image only to electrodes associated with pixels different from pixels in the previous display, based on pixel data stored as the previous display data and the current display data. The CPU 2 issues commands for controlling the amount of voltage applied to each electrode corresponding to each pixel of the display changed by commands from the display controller 3.

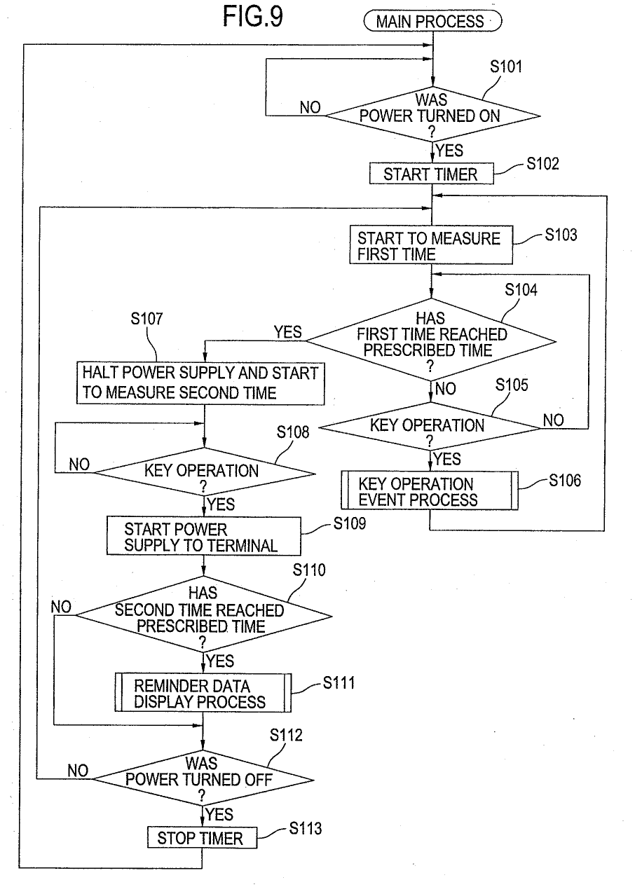

Next, the operations and effects of the browsing terminal according to the first embodiment described above will be described while referring to FIGS. 9 through 12. FIG. 9 is a flowchart illustrating steps in a main process performed on the browsing terminal 1. The CPU 2 implements this main process by executing the main operation program stored in the main operation program storage area 902 after the power is supplied to the CPU 2 and power supply controller 12 of the browsing terminal 1 by connecting the browsing terminal 1 to an external power supply, such as batteries or a commercial power supply connected via an outlet.

First, the CPU 2 determines whether the user has turned on the power to the browsing terminal 1 in S101. The power switch may be configured in hardware or may be a switch implemented in software. The CPU 2 repeats the process in S101 when the CPU 2 determines that the power switch is off (S101: NO), and advances to S102 when the CPU 2 determines that the power switch is on (S101: YES).

In S102, the timer 22 starts to measure a time. In S103 the timer 22 starts to measure a first time, in order to determine whether an operation on the operating keys 81-84 has been performed within a prescribed time period. Specifically, the CPU 2 in S103 stores, in the RAM 10, time data representing time when the timer 22 starts to measure. The first time indicates the elapsed time in which the display has not been changed by an operation of the operating keys 81-84. In the first embodiment, the display image on the electrophoretic display unit 4 is switched in response to an operation on the operating keys 81-84.

In S104 the CPU 2 determines whether the first time reaches a first prescribed time. The first time is calculated by the CPU 2, and is a difference between a time measured by the timer 22 in S104 and the time represented by the time data stored in the RAM 10 in S103. The CPU 2 advances to S105 if the prescribed time has not elapsed (S104: NO), and advances to S107 if the prescribed time has elapsed (S104: YES).

In S105, the CPU 2 determines whether one of the operating keys 81-84 was operated. The CPU 2 advances to S106 when detecting the operation of one of the operating keys 81-84. (S105: YES), and returns to S104 when such an operation was not detected (S105: NO).

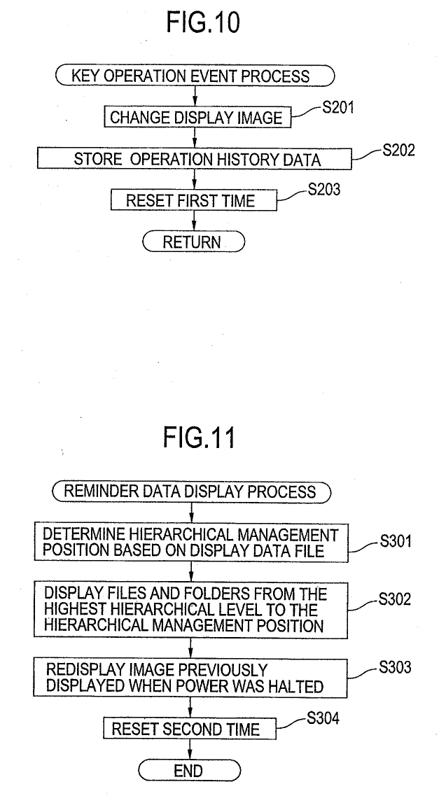

In S106, the CPU 2 reads the key operation event program from the key operation event program storage area 903 and performs the key operation event process (FIG. 10). Here, a key operation event is an operation to switch the display image on the electrophoretic display unit 4. In other words, the display image on the electrophoretic display unit 4 is switched in response to an operation of the operating keys 81-84. At this time, data related to switching the display image on the electrophoretic display unit 4 is stored in the terminal operation history storage area 620 as the operation history data. The CPU 2 ends the key operation event process and returns to S103.

FIG. 10 is a flowchart illustrating steps in the key operation event process. In S201 at the beginning of this process, the CPU 2 switches the display data for the electrophoretic display unit 4 based on the operation of the operating keys 81-84 according to the display data file and the currently displayed page data. In the following description, it will be assumed that the folder name “Chapter 1—Introduction” and the filename “1.2 Problem” shown in FIG. 8 are stored as the current display file data and the page number “3” shown in FIG. 8 is stored as the current display page data, and it will also be assumed that the user operated the operating key 84 to switch from page number “3” to page number “4”. That is, in response to the user pressing the operating key 84, the CPU 2 reads display data for page number “4” stored in the file “1.2 Problem” from the display data storage area 610, with the file “1.2 Problem” serving as the display data file and the page number “3” serving as the current display page data. The CPU 2 stores the display data corresponding to page number “4” and the coordinate data for this display data stored in the file “1.2 Problem” in the page development data storage area 1003 as the page development data. Then, the CPU 2 copies and stores the display data identical to that the current display data as the previous display data. Next, the CPU 2 generates and stores, as new current display data, new pixel data corresponding to a next display image to be displayed on the electrophoretic display unit 4, based on the coordinate data stored as page development data. The CPU 2 displays the current display image on the electrophoretic display unit 4 by outputting the current display data to the electrophoretic display unit 4. In the first embodiment, the CPU 2 compares the pixel data stored in the current display data storage area 1002 to that stored in the previous display data storage area 1001, and controls the display controller 3 to transmit instructions for changing the display based on the results of this comparison only to electrodes corresponding to pixels different from pixels in the previous display data.

In S202 the CPU 2 stores the operation history data in the operation history storage area 620. The following description will use the case of operation history number “9” in which the user presses the operating key 84 in S201 to switch from page 3 to page 4 in the file “1.2 Problem” of the current display data shown in FIG. 8. As described in FIG. 7, the CPU 2 temporarily stores “change display” as the event data, the operation data “operating key 84” detected in S105 as the key operation data, page data corresponding to page 4 in the file “1.2 Problem” as the display history data “display data 10”, and the time “3:29:00” as the time data. The time “3:29:00” is measured by the timer 22 and represents the time at which the display image was switched. In other words, the time data stored in S202 represents the elapsed time from the timer 22 starts to count in S102 until the display image was switched. At the same time, the CPU 2 stores, as the current display data file, the folder name “Chapter 1—Introduction” and the filename “1.2 Problem” in which are managed the current display data (page data corresponding to the page 4 of the file “1.2 Problem”. Further, the CPU 2 stores the page number “4” as the current display page data.

In S203, the CPU 2 resets the first time and subsequently ends the key operation event process. The CPU 2 deletes the time stored in the RAM 10 in S103, when the CPU 2 resets the first time.

Returning to FIG. 9, if the CPU 2 determines that the first time has reached to a prescribed time (S104: YES), the timer 22 starts to count a second time and halts the supply of power to the browsing terminal 1 in S107. Specifically, the CPU 2 controls the system power switch 20 to disconnect the power supply block 99 and system power supply 30. In S107, the CPU 2 stores, in the memory card 6, time data representing the time that is measured by the timer 22 when the CPU 2 performs in S107. In other words, the second time is the time has elapsed since the electrophoretic display unit 4 was set to the interruption mode until the electrophoretic display unit 4 is set to the operation mode. The second time data represents a time that has been elapsed after the CPU 2 halts the supply of power to the browsing terminal 1 and before the CPU 2 supplies of power to the browsing terminal 1 again. Just prior to halting the supply of power to the browsing terminal 1, the CPU 2 stores the event data, the key operation data, the display history data, and the time data in the memory card 6 as the operation history data related to the current display data.

The following description is for the case in which operation history data for number “10” shown in FIG. 7 are stored in the display history data storage area 623. Before the supply of power to the browsing terminal 1 is cut off, the CPU 2 stores “halt power supply” as the event data for the operation history number “10”. At the same time, the CPU 2 stores “null” as the key operation data for the operation history number “10”. The display data “display data 10” displayed just prior to the power supply being shut down is stored as the display history data. The time “3:35:40” at which the supply of power to the browsing terminal 1 was stopped is stored as the time data. The time “3:35:40” is indicated by the timer 22 immediately until the supply of power to the browsing terminal 1 was stopped. In other words, the time data represents the elapsed time from the timer 2 starts in S102 immediately until the supply of power to the browsing terminal 1 was stopped. The CPU 2 halts the supply of power after the CPU 2 has stored the operation history data. Next, a three-page display data file stored under the filename “1.2 Problem” at the hierarchical position “Main Menu/Document/Title—Experiment Report/Chapter 1—Introduction” will be described using the display history data for operation history number “10”.

Returning to FIG. 9, in S108 the CPU 2 determines whether one of the operating keys 81-84 was operated. The CPU 2 repeatedly executes the determination in S108 when the CPU 2 determines that no operation key is operated (S108: NO), and subsequently advances to S109 when one of the operating keys 81-84 is operated (S108: YES).

In S109 the CPU 2 begins supplying a power to the browsing terminal 1 based on the determination that an operation key was pressed in S108. Specifically, the CPU 2 controls the system power switch 20 to connect the power supply block 99 and the system power supply 30.

In S110, the CPU 2 determines whether the second time has reached a prescribed time. The second time is a difference between the time counted by the timer 22 in S110 and the time stored in the memory card 6 in S107. The CPU 2 advances to S112 if the second time has not reached the prescribed time (S110: NO), and advances to S111 if the second time has reached the prescribed time (S110: YES).

In S111 the CPU 2 reads the reminder data display program stored in the reminder data display program storage area 904 shown in FIG. 5, and executes a reminder data display process in accordance with this program. In the reminder data display process, the CPU 2 displays, based on the reminder data, reminder image for reminding the user about display image that is displayed on the electrophoretic display unit 4 while the power supply to the browsing terminal 1 has been cut off. In the first embodiment, the CPU 2 displays the reminder image based on hierarchical management position data of display file data. For example, when the file “1.2 Problem” is the current display data file, the CPU 2 displays the reminder image on the electrophoretic display data, the reminder image including information about the files managed at the same hierarchical level and the folders managed at the higher hierarchical level than the current display file data. For example, the reminder image includes the names of the file “1.1 Overview” and the folders “Chapter 1—Introduction,” “Chapter 2—Experiments,” and “Chapter 3—Conclusion”.

FIG. 11 is a flowchart illustrating steps in the reminder data display process. In S301 at the beginning of the reminder data display process, the CPU 2 reads the display data file stored in the display data file storage area 1102 as relation data that is related to the current display data. By executing the file management program stored in the file management program storage area 901, the CPU 2 determines, as the hierarchical management position, a hierarchical position at which the current display data is managed as a file based on the display data file. In the first embodiment, the hierarchical management position is the hierarchical position of “Main Menu/Document/Title—Experiment Report/Chapter 1—Introduction”. As shown in FIG. 6, the display data file 92-b is managed under the name “1.2 Problem” at the hierarchical management position.

In S302 the CPU 2 displays, the reminder images on the electrophoretic display unit 4, in descending order from the highest hierarchical level to the hierarchical management position determined in S301. Each reminder image is displayed based on hierarchical position data. The hierarchical position data represents the folder names and filenames that are positioned the subject hierarchical position and the folder names and filenames that are positioned hierarchical positions higher than the subject hierarchical position.

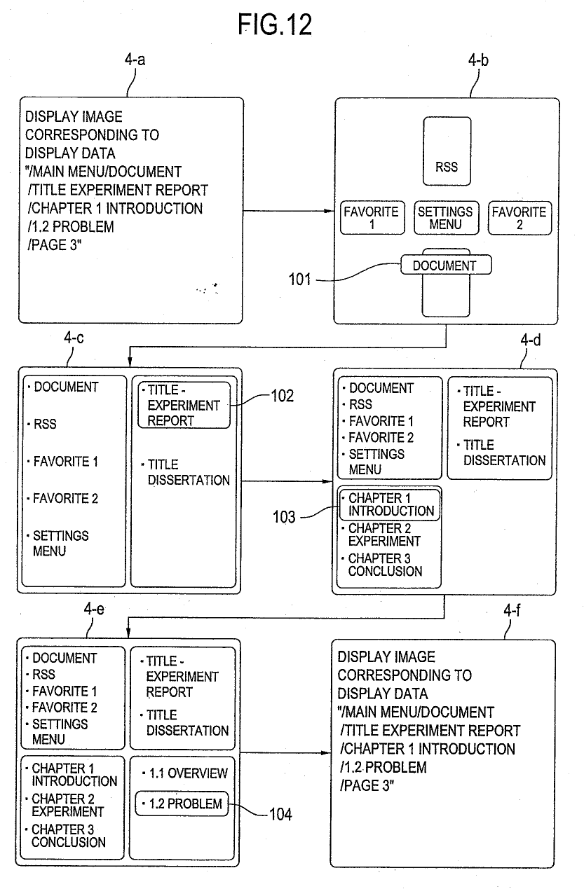

FIG. 12 is a conceptual diagram showing an example of changing display images based on the hierarchical position data in descending order from the highest hierarchical level. Display screens 4-a through 4-f shown in FIG. 12 are enlarged views of the display screen on the electrophoretic display unit 4. As shown in the upper left of FIG. 12, the display screen 4-a shows the display image displayed based on the display data for the third page contained in the display data file “1.2 Problem” 92-b (see FIG. 6) in the hierarchical position “Main Menu/Document/Title—Experiment Report/Chapter 1—Introduction,” which was displayed just before the supply of power was halted in S107. Beginning from display screen 4-b shown in FIG. 12, the CPU 2 in S302 displays the display screens 4-b, 4-c, 4-d, and 4-e for prescribed intervals on the electrophoretic display unit 4 in the order indicated by arrows in FIG. 12. Hence, the hierarchical folders and files shown in display screens 4-b through 4-e are displayed on the electrophoretic display unit 4. In the display screen 4-b, the CPU 2 displays the names of the folders “Document,” “RSS,” “Favorite 1,” “Favorite 2,” and “Option Menu.” According to display screen 4-c, the CPU 2 displays the names of the folders “Document,” “RSS,” “Favorite 1,” “Favorite 2,” and “Option Menu,” and also displays the names of folders “Title—Experiment Report” and “Title—Research Paper” in the hierarchical level beneath the folders having the folder names that are displayed in the display screen 4-b. In the display screen 4-d, the CPU 2 displays the folder names that are displayed in display screen 4-c, as well as the folders “Chapter 1—Introduction,” “Chapter 2—Experiments,” and “Chapter 3—Conclusion” in the hierarchical level directly beneath the folders having folder names that are displayed in the display screen 4-c. In the display screen 4-e, the CPU 2 displays the folder names shown in the display screen 4-d, as well as the files “1.1 Overview” and “1.2 Problem” in the hierarchical level directly beneath the folders having the folder names that are displayed in the display screen 4-d.

Identification data 101-104 shown in FIG. 12 identifies folders storing a display data file stored under the name “1.2 Problem” in the hierarchical position “Main Menu/Document/Title—Experiment Report/Chapter 1—Introduction” or the file itself. The CPU 2 generates, for each hierarchical position, the identification data 101-104. The identification data represents the first display data and folders in which the current display data is managed.

Specifically, the CPU 2 executes the file management program in order to determine the identification data 101-104 based on the display data file in the EEPROM 11. In the example of display screen 4-b, the identification data 101 has been assigned to the folder “Document,” storing the current display data file “1.2 Problem.” In the display screen 4-c, the identification data 102 has been assigned to the folder “Title—Experiment Report” storing the current display data file “1.2 Problem.” In the display screen 4-d, the identification data 103 has been assigned to the folder “Chapter 1—Introduction.” In the display screen 4-e, the identification data 104 has been assigned to the current display data file “1.2 Problem” itself. By assigning this identification data, the user can understand the hierarchical position at which the current display file data is managed.

In S303, as shown in the display screen 4-f indicated by the last arrow in FIG. 12, the CPU 2 again displays display image based on the display data for page 3 contained in the current display data file 92-b having the filename “1.2 Problem” and stored in the hierarchical position “Main Menu/Document/Title—Experiment Report/Chapter 1—Introduction,” which the display image was displayed when the supply of power was halted in S107.

In S304 the CPU 2 resets the second time and subsequently ends the reminder data display process. The CPU 2 deletes the time data stored in the memory card 6 in S107, when the CPU 2 resets the second time.

Returning to FIG. 9, in S112 the CPU 2 determines whether the power switch was turned off. The CPU 2 returns to S103 when the power switch was not turned off (S112: NO) and advances to S113 when the power switch was turned off (S112: YES). In S113, the timer 22 stops to count time and returns to S101.

According to the first embodiment, the user can remind the state of browsing at previous time by checking the reminder images, the reminder images including the title name, the chapter names, and the number of pages. Specifically, in the first embodiment, the CPU 2 displays the reminder image based on the reminder data on the electrophoretic display unit 4 when the CPU 2 switches a mode of the browsing terminal 1 from an interruption mode to an operation mode, in other words, when the power is supplied to the browsing terminal 1 after the supply of power is interrupted. Therefore, the browsing terminal 1 enables the user to remind information and content that are related to the current display image, such as a browsing state at which the current display image has been displayed at the previous time, and a type of browsing at the previous time.

Further, in the first embodiment, the CPU 2 displays, as the reminder images, the files and folders that are managed at the hierarchical management position and the one higher hierarchical levels than the hierarchical management position. Accordingly, the user can easily remind the content of the current display image by checking a relation between the display image and the files and folders.

Further, the CPU 2 displays the reminder images including the identification data. The identification data represents the file and folder at which the current display image data is managed. Each filename and folder name corresponding to the identification data is surrounded with circle or square in the remind image. Accordingly, the user can easily determine the file in which the current display data is included, when a plurality of filenames and folder names are displayed in the remind image.

While the invention has been described in detail with reference to the first embodiment thereof, it would be apparent to those skilled in the art that various changes and modifications may be made therein without departing from the spirit of the invention.

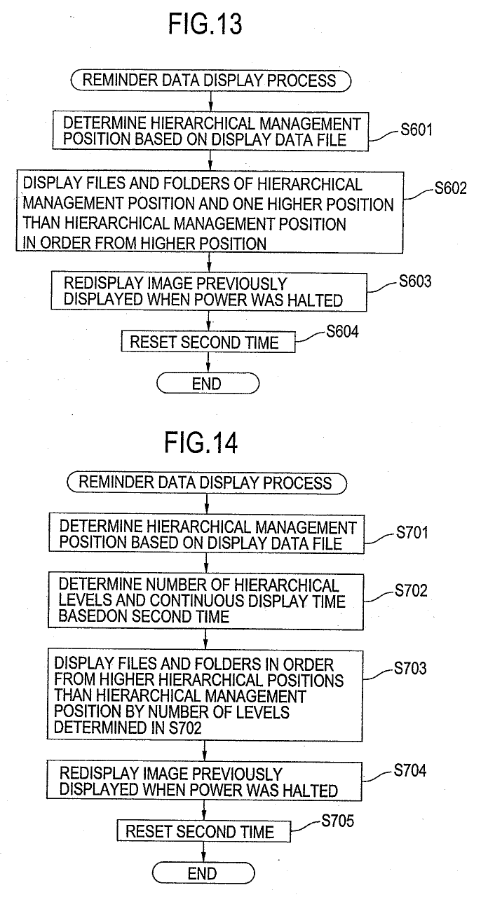

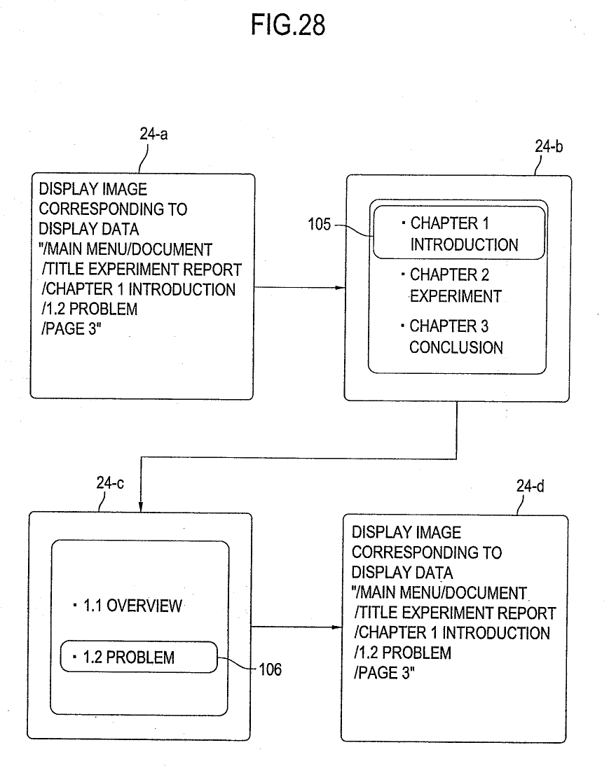

Next, a reminder data display process according to a first variation of the first embodiment will be described while referring to FIG. 13 and FIG. 28.

FIG. 13 is a flowchart illustrating steps in the reminder data display process according to the first variation. In S601 the CPU 2 reads the current display data file and the current display page data from the EEPROM 11 as the related data to the current display image displayed on the electrophoretic display unit 4. The CPU 2 executes the file management program to determine, based on the current display data file, the hierarchical management position at which the current display data is managed.

In S602 the CPU 2 displays, on the electrophoretic display unit 4, the filenames and folder names corresponding to the files and folders that are positioned at the hierarchical management position determined in S601 and that are positioned a hierarchical position higher than the hierarchical management position for one hierarchical level in descending order from the higher position, as shown in FIG. 28.

In S602, the CPU 2 displays each of the display screens 24-b and 24-c for prescribed intervals on the electrophoretic display unit 4 and in the order indicated by the arrows in FIG. 28. The display screen 24-c represents folders and files that are positioned at the hierarchical management position, and includes identification data 106. In other words, the display screen 24-c indicates all files that are positioned at the same hierarchal position at which the previous display image just before the supply of power was halted corresponding to the display data file is managed. The display screen 24-b represents folders and files that are positioned at the hierarchical position higher than the hierarchical management position for one hierarchical level. In other words, the display screen 24-b indicates all folders and files that are managed at the hierarchal position higher for one level than the hierarchical management position at which the current display data corresponding to the display image that is displayed just before the supply of power was halted. The display screen 24-b includes identification data 105. The identification data 105 and 106 are the names of the folders and files that store the current display data.

In S603 the CPU 2 displays display screen 24-d on the electrophoretic display unit 4. In other words, the CPU 2 redisplays the display screen 24-a that was displayed just before the power supplied to the browsing terminal 1 was halted in S106.

In S604 the CPU 2 resets the second time and subsequently ends the reminder data display process. While the CPU 2 displays the names of files and folders at the hierarchical management position and the hierarchical level higher than the hierarchical management position for one level in the reminder image in the first variation, the CPU 2 may displays the names of the files and the folders that are positioned at the hierarchical management position and a plurality of hierarchical levels higher than the hierarchical management position.

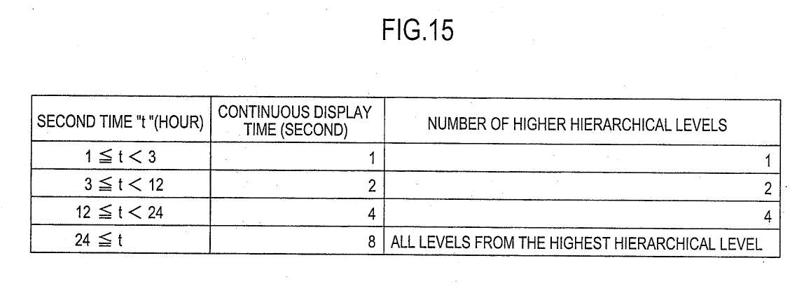

Next, a reminder data display process according to a second variation of the first embodiment will be described while referring to FIGS. 14 and 15.

FIG. 14 is a flowchart illustrating steps in the reminder data display process according to the second variation. In S701 at the beginning of the reminder data display process, the CPU 2 reads the current display data file and the current display page data from the EEPROM 11 as the related data related to the current display data. The CPU 2 executes the file management program to determine the hierarchical management position at which the current display data is managed, based on the display data file.

In S702, the CPU 2 determines a number of hierarchical levels to be displayed in the reminder image and a continuous display time for maintaining the reminder image on the electrophoretic display unit 4 based on the second time counted by the timer 22. FIG. 15 is an explanatory diagram showing data structure of the continuous display time data storage area 630 as continuous display time data. The continuous display time data storage area 630 stores the continuous display time data and the number of hierarchical level associated with the second time data. In the following description of the second variation, it will be assumed that the second time has counted seven hours by the timer 22. Based on the table shown in FIG. 15, the continuous display time is determined to “2” seconds and the number of hierarchical levels to “2”, for seven hours as the second time.

In S703, the CPU 2 displays the hierarchical position data on the electrophoretic display unit 4, the hierarchical position data representing the files and folders that are positioned at the hierarchical position higher than the hierarchical management position determined in S701 for the number of hierarchical levels determined in S702, in descending order from the highest hierarchical level to the hierarchical management position.

In S704, the CPU 2 redisplays the display image that was displayed on the electrophoretic display unit 4 just before the supply of power to the browsing terminal 1 was halted in S107 (FIG. 9). In S705 the CPU 2 resets the second time and subsequently ends the reminder data display process.

In the second variation of the first embodiment, the CPU 2 determines the continuous display time for maintaining the reminder image on the electrophoretic display unit 4, based on the second time. Specifically, the CPU 2 determines a long time as the continuous display time, when the time has been elapsed since the CPU 2 switches from the operation mode to the interruption mode for a long time. This is because the content of display image is more difficult for the user to remind when the time has been elapsed for a longer time. Accordingly, the browsing terminal 1 can provide aid for the user to efficiently remind the content of display image that is displayed at the previous time.

Further, the timer 22 measures the second time, the second time representing a time that has elapsed since the CPU 2 switched the mode of the browsing terminal 1 from the interruption mode to the operation mode. Based on the second time, the CPU 2 determines whether the CPU 2 outputs the reminder image to the display controller 3. Specifically, because the user can easily remind the content of current display image (the display image that was displayed last at the previous time) when the short time has elapsed since the CPU 2 switched the mode from the interruption mode to the operation mode, the CPU 2 fails to display the reminder image when the second time does not reach the prescribed time. However, the CPU 2 displays the reminder data on the electrophoretic display when the second time has reached the prescribed time. Therefore, the user can remind the content of the current display image based on the reminder images, even if time has elapsed for a long time. That is, the browsing terminal 1 displays the reminder images only when it is absolutely necessary, and enables the user to efficiently perform the browsing on the browsing terminal 1.

Further, the CPU 2 maintains the reminder images on the electrophoretic display unit 4 for the continuous display time since the CPU 2 sets the browsing terminal 1 to the operation mode. Accordingly, the user can more reliably remind the content of display image by checking the remind image for continuous display time.

Further, while the CPU 2 determines the number of hierarchical levels for displaying the display images in S702, but the number of hierarchical levels may be determined preliminary.

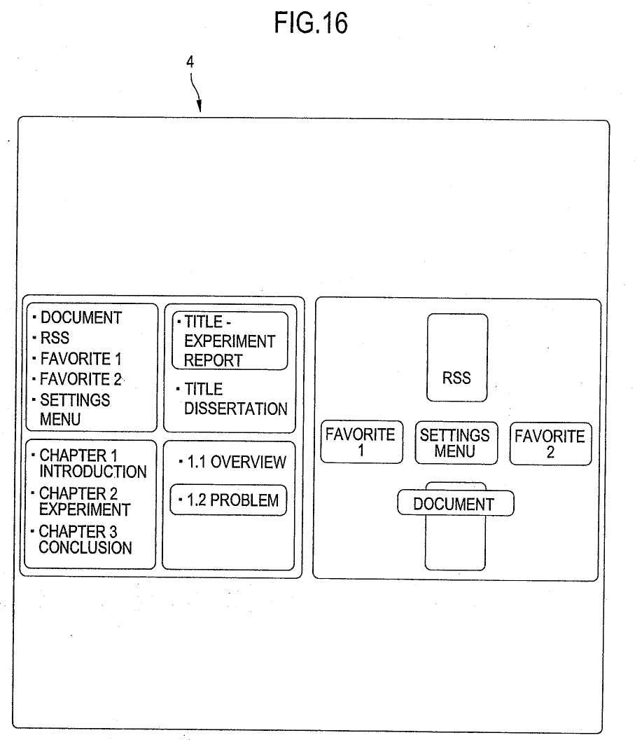

Further, all files and folders that are positioned at all hierarchical positions may be displayed at once in the reminder image as shown in FIG. 16, rather than displaying the files and folders in descending order of height of hierarchical levels.

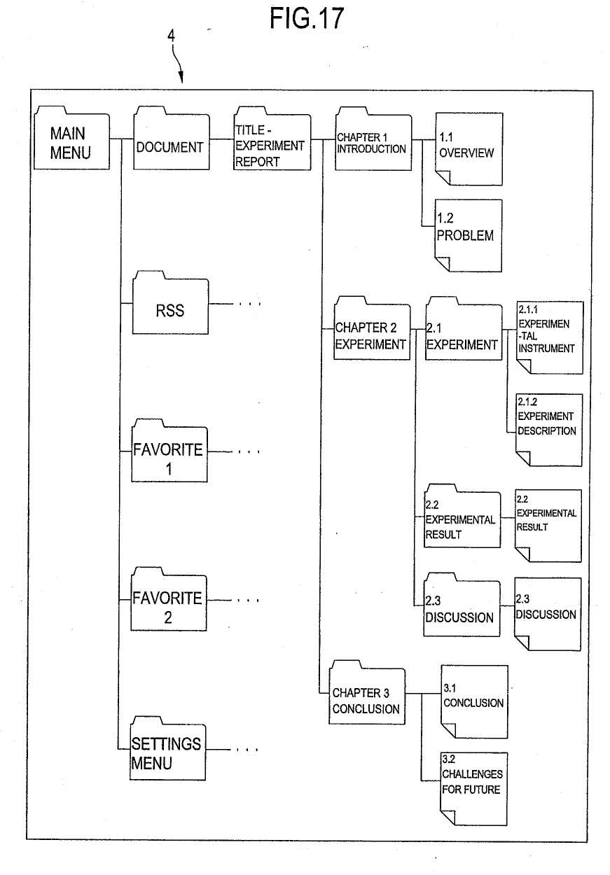

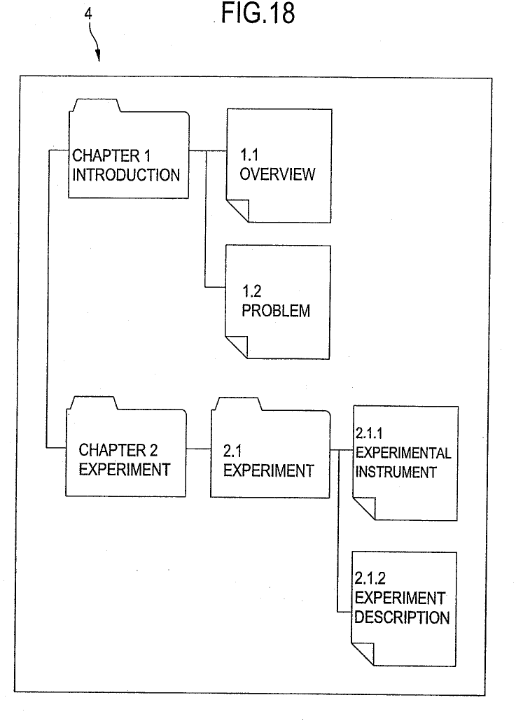

Alternatively, all of the files and folders may be displayed in the reminder image as shown in FIG. 17. Further, a portion of the files and folders may be displayed as shown in FIG. 18. Further, the path from a high-order hierarchical level to the hierarchical management position may be displayed in text form.

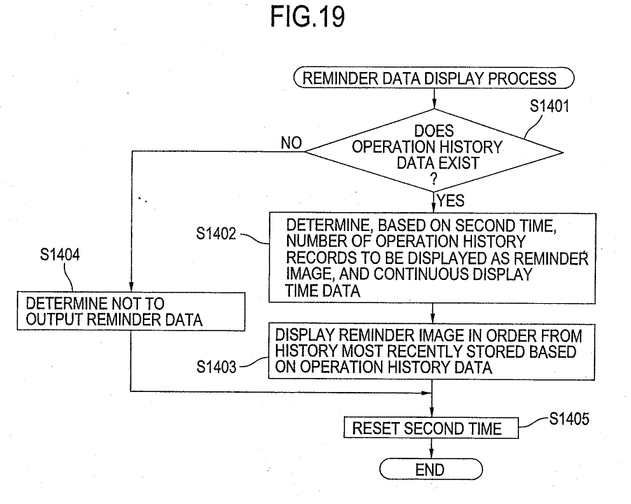

Next, a second embodiment in which the present invention is applied to the browsing terminal 1 will be described while referring to FIGS. 19 through 21. Since the external structure and electrical configuration of the browsing terminal 1 according to the second embodiment is substantially the same as that in the first embodiment, only different aspects will be described below. In the second embodiment, the CPU 2 determines the reminder data, based on the display history data stored on the memory card 6 (FIG. 7).

FIG. 19 is a flowchart illustrating steps in a reminder data display process according to the second embodiment. In S1401, the CPU 2 determines whether operation history data has been stored in the operation history storage area 623. The CPU 2 advances to S1402 when operation history data is stored in the operation history storage area 623 (S1401: YES), and advances to S1404 when no operation history has been stored in the operation history storage area 623 (S1401: NO).

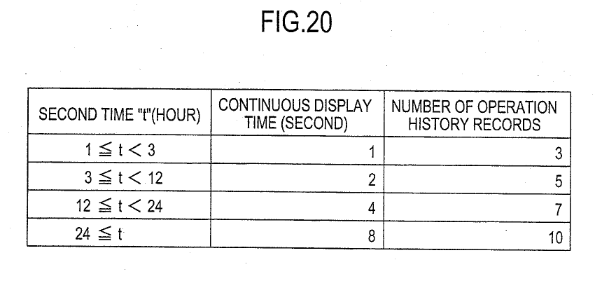

In S1402 the CPU 2 determines, based on the second time measured by the timer 22, the number of operation history records corresponding to the reminder images and the continuous display time for maintaining the reminder images on the electrophoretic display unit 4. In the following description of the second embodiment, it will be assumed that the second time has reached seven hours. FIG. 20 is a conceptual diagram showing the configuration of the table stored in the memory card 6. As shown in FIG. 20, continuous display time data and the numbers of operation history records are associated with the second time stored in the continuous display time data storage area 630 (FIG. 5). Based on the content in the table shown in FIG. 20, the CPU 2 determines that the continuous display time is “2” seconds and that the number of operation history records is “5” when the second time is seven hours.

In S1403, the CPU 2 displays, as the reminder images, the display images that were previously displayed on the electrophoretic display unit 4 until the present time in accordance with the operation history data. In this example, the CPU 2 displays five display images based on the five records of operation history data since the operation history number “5” was determined in S1402. Therefore, the CPU 2 reads five records of display history data from the memory card 6 having operation history numbers “6” through “10”, as shown in FIG. 7 in order of storing recently, and displays these records on the electrophoretic display unit 4 in the order of display history records from the oldest to newest. In other words, the CPU 2 reads five records of display history data having the history number in order of largest to smallest, and displays these records on the electrophoretic display unit 4 in the order of smallest to largest.

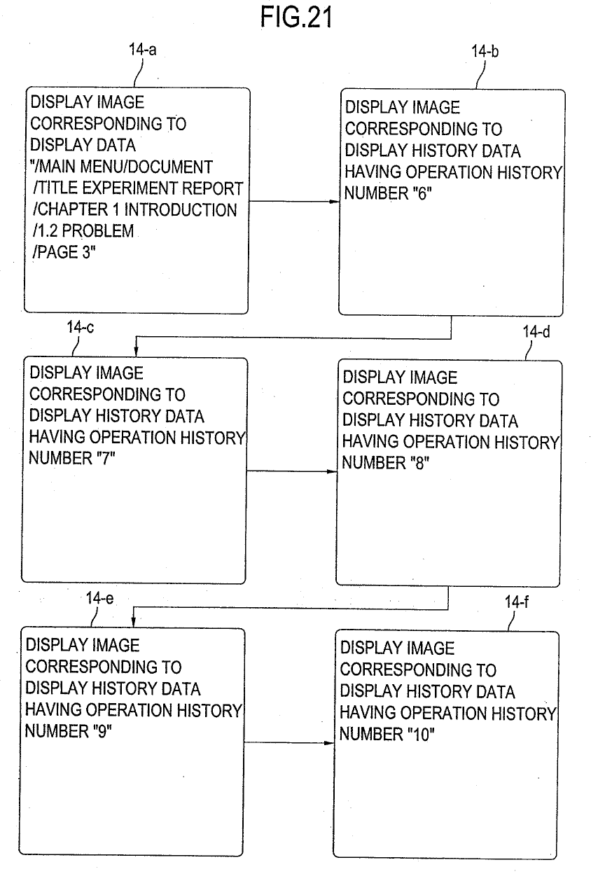

FIG. 21 is an explanatory diagram conceptually illustrating screen displays that are displayed on the electrophoretic display unit 4 corresponding to the display history data in the order from oldest to newest. Display screens 14-a through 14-f shown in FIG. 21 are enlarged views of the display screen on the electrophoretic display unit 4. The display screen 14-a in the upper left of FIG. 21 shows an example of display image based on the display data for the third page contained in the current display data file “1.2 Problem” at the hierarchical position “Main Menu/Document/Title—Experiment Report/Chapter 1—Introduction.”

Each display screen 14-b, 14-c, 14-d, 14-e, and 14-f shows that the CPU 2 displays the display images corresponding to the operation history number “6”, “7”, “8”, “9”, and “10”, respectively. Beginning from display screen 14-a shown in the upper left of FIG. 21, the CPU 2 in S1403 displays each of the display screens 14-b, 14-c, 14-d, 14-e, and 14-f for prescribed intervals on the electrophoretic display unit 4 and in the order indicated by the arrows. In other words, the CPU 2 displays the display screens in order of storing chronologically from oldest to newest. The display image shown in each of the display screens 14-b through 14-f are displayed on the electrophoretic display unit 4 as the reminder image. The CPU 2 maintains the displaying the reminder image shown in the display screens of FIG. 21 for two seconds based on the continuous display time determined in S1402.

In S1404 the CPU 2 determines that reminder image will be not outputted since the operation history data does not exist for generating the reminder image. The CPU 2 may also display a message on the electrophoretic display unit 4 in S1404 indicating that reminder data will not be outputted. In S1405 the CPU 2 resets the second time and subsequently ends the reminder data display process.

In the second embodiment, the CPU 2 determines, based on the second time, the number of operation history records corresponding the reminder images to be displayed on the electrophoretic display unit 4. Accordingly, the user can check more number of the reminder images when the longer time has elapsed since the display image is displayed at the previous time.

Further, the CPU 2 displays, on the electrophoretic display unit 4, the display data corresponding to the display history data in the order of the display history stored in the display data storage area 623. Accordingly, the user can easily remind the content of the current display image by checking the reenactment of the previous operations based on the display history data.

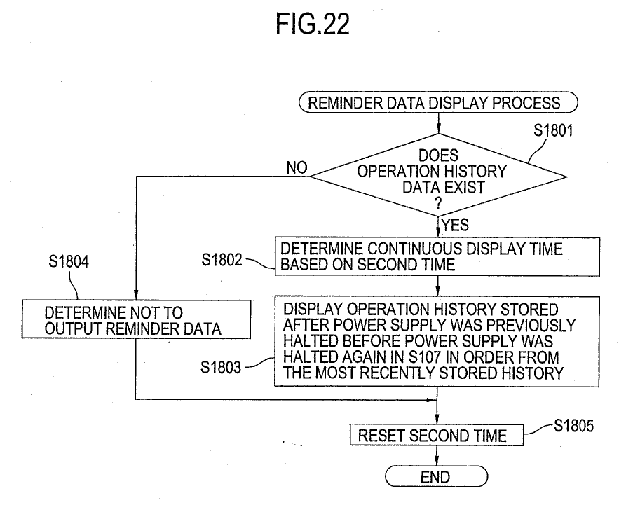

Next, a variation of the reminder data display process according to the second embodiment will be described while referring to FIG. 22.

FIG. 22 is a flowchart illustrating steps in a reminder data display process according to the variation of the second embodiment. In S1801 at the beginning step of the reminder data display process, the CPU 2 determines whether the operation history data has been stored in the operation history storage area 620. The CPU 2 advances to S1804 if no terminal operation history data exists (S1801: NO), and advances to S1802 if terminal operation history data exists (S1801: YES).

In S1802 the CPU 2 determines the continuous display time for maintaining the display of reminder image on the electrophoretic display unit 4, based on the second time.

In S1803 the CPU 2 generates, based on the operation history data, the reminder images corresponding to the display images that were previously displayed on the electrophoretic display unit 4, and displays the reminder images on the electrophoretic display unit 4 based on the reminder data. Here, the CPU 2 displays the reminder images based on the history of operations stored as the operation history data prior to the current stoppage of power in S107 and after the previous stoppage of power. Hence, “halt power supply” is stored as the event data for operation history number “3” in FIG. 7. Thereafter, the CPU 2 stores “change display” as the event data for operation history numbers “4” through “9” and stores “halt power supply” as the event data for operation history number “10”. Accordingly, the operation history data for operation history numbers “3” through “10” are the history of operations stored before the supply of power was halted in S107 and after the supply of power was previously halted. Accordingly, the reminder display images representing display history data corresponding to operation history numbers “3” through “10” are displayed on the electrophoretic display unit 4 in order from oldest to newest (in order of history number from smallest to largest).

In S1804, the CPU 2 determines that reminder image will not be outputted, since there exists no terminal operation history data as the reminder data for generating the reminder images. The CPU 2 may also display, on the electrophoretic display unit 4, a message indicating that reminder image will not be outputted. In S1805 the CPU 2 resets the second time and subsequently ends the reminder data display process.

Further, as another variation of the reminder data display process according to the second embodiment, the number of operation history records may be preset rather than determining this number in S1402.

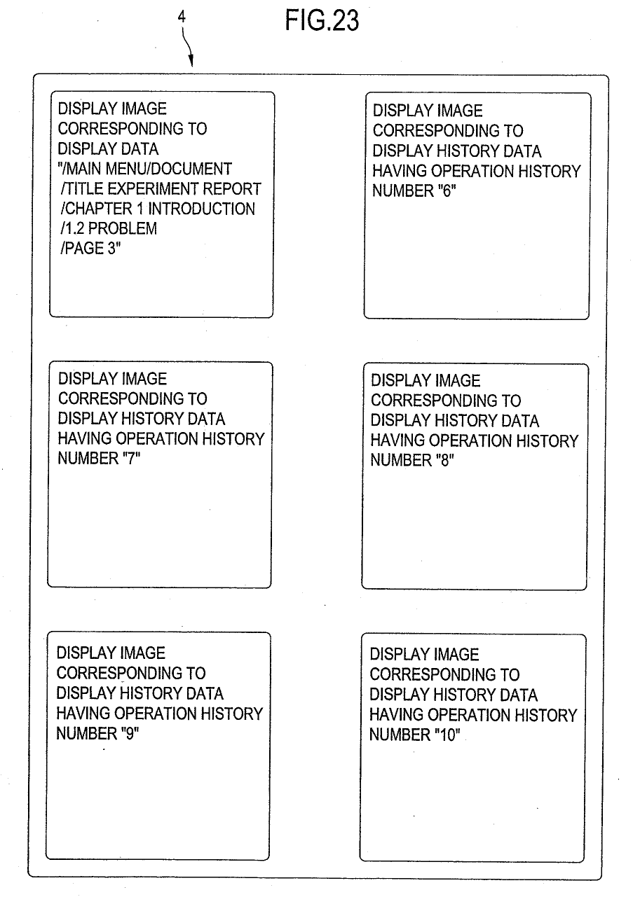

Further, while the CPU 2 displays the operation history in order from oldest to newest in S1403 of the reminder data display process according to the second embodiment, the CPU 2 may display one reminder image representing all operation history at once shown in FIG. 23.

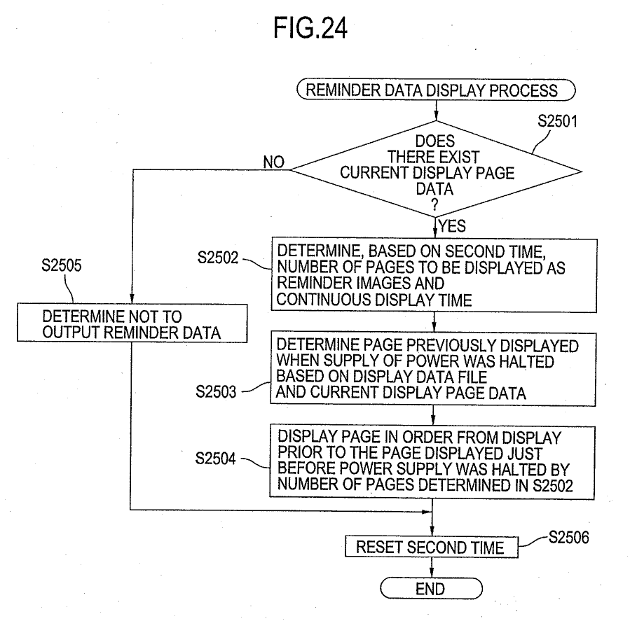

Next, a reminder data display process according to a third embodiment will be described with reference to FIGS. 24 through 26. Since the external structure and electrical configuration of the browsing terminal 1 according to the third embodiment is substantially the same as that in the first embodiment, only different aspects will be described below. In the third embodiment, the CPU 2 displays, as the reminder images, display images based on both the current display page data stored in the display page data storage area 1103 and at least one set of display data having the page number smaller than the current display page data (the page number stored in the display page data storage area 1103), in order of page number from smaller to the current display page data.

FIG. 24 is a flowchart illustrating steps in the reminder data display process according to the third embodiment. In S2501 at the beginning of the reminder data display process, the CPU 2 determines whether the page number is stored as the current display page data in the current display page data storage area 1103. The CPU 2 advances to S2506 if the current display page data is “null” (S2501: NO), and advances to S2502 if the current display page data is stored in the current display page data storage area 1103 (S2501: YES).

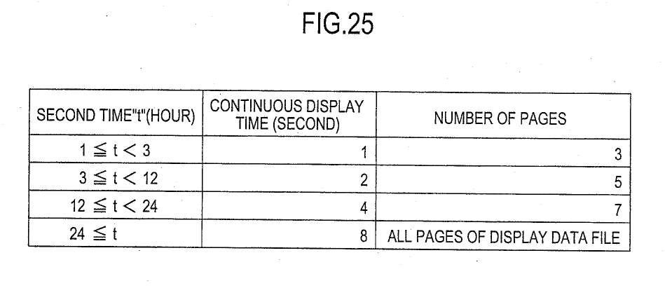

In S2502 the CPU 2 determines the number of pages to be displayed as the reminder images and the continuous display time for maintaining the display of reminder images on the electrophoretic display unit 4 based on the second time. FIG. 25 is an explanatory diagram showing a table stored on the memory card 6, the continuous display time corresponding to the second time and the number of pages to be displayed as the reminder images in the table. Here, the following description for the third embodiment will assume that the second time has reached to seven hours. According to the table shown in FIG. 25, the CPU 2 determines the continuous display time to 2 seconds and the number of pages as the reminder images to “5” when the second time has reached to seven hours.

In S2503 the CPU 2 determines, based on the current display data file and the current display page data, the current display image displayed on the electrophoretic display unit 4 just before the supply of power was halted in S107, and the page number for the current display data.

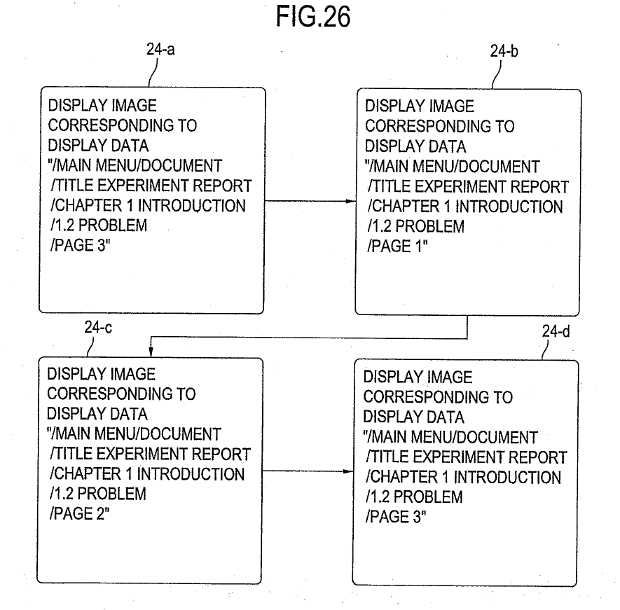

In S2504 the CPU 2 outputs reminder data to the electrophoretic display unit 4 based on the display data and page number set in S2503 and the number of pages and continuous display time set in S2502. In the third embodiment, the CPU 2 displays the display images as the reminder images on the electrophoretic display unit 4, in increasing order of page number. If the page number stored as the current display page data is smaller than the number of pages determined in S2502, the CPU 2 displays the reminder images on the electrophoretic display unit 4 from the first page in the current display data file to the current display page data. In the following example, it will be assumed that “1.2 Problem” is stored as the current display data file and “3” is stored as the current display page data. In the third embodiment, when the page number “3” stored as the current display page data is smaller than the number of pages “5” determined in S2502, the CPU 2 displays the reminder images on the electrophoretic display unit 4 from the first page of the current display data file to the third page. FIG. 26 is an explanatory diagram showing the reminder images that are displayed on the electrophoretic display unit 4 based on the number of pages determined in S2502. Each reminder image is displayed for prescribed intervals in increasing order of page numbers. Display screens 24-a through 24-c shown in FIG. 26 are enlarged diagrams of display screens on the electrophoretic display unit 4. The display screen 24-a shown in the upper left of FIG. 26 shows the display image corresponding to the display data for the third page contained in the current display data file “1.2 Problem” 92-b (FIG. 7) at the hierarchical position “Main Menu/Document/Title—Experiment Report/Chapter 1—Introduction,” which the display image was displayed on the electrophoretic display unit 4 just before the supply of power was halted in S107. The display screen 24-b, 24-c, and 24-d shows the reminder image corresponding to the display data for the first, second, and third page of the current display data file 92-b, respectively.

The display screen 24-d indicated by the final arrow in FIG. 26 is identical to the display screen 24-a that is last displayed before the power supply was shut off in S107. In other words, in S2504 the CPU 2 displays the display screen 24-a (24-d) again.

In S2505, the CPU 2 determines that the reminder data will not be outputted since there exists no current display page data to be used for generating the reminder data. The CPU 2 may also display, on the electrophoretic display unit 4, a message indicating that reminder data will not be outputted in S2505. In S2506 the CPU 2 resets the second time and subsequently ends the reminder data display process.

In the third embodiment, the CPU 2 displays, on the electrophoretic display unit 4, the reminder images corresponding to the page numbers smaller than the page number of the current display data. Accordingly, the user can easily remind the content of the current display image from the context in the pages.

Further, since the CPU 2 displays the reminder images in ascending order of page numbers, the user can easily and efficiently remind the content of the currently displayed image.

In the reminder data display process according to the third embodiment, the number of reminder images to be displayed may be preset rather than determining this number in S2502.

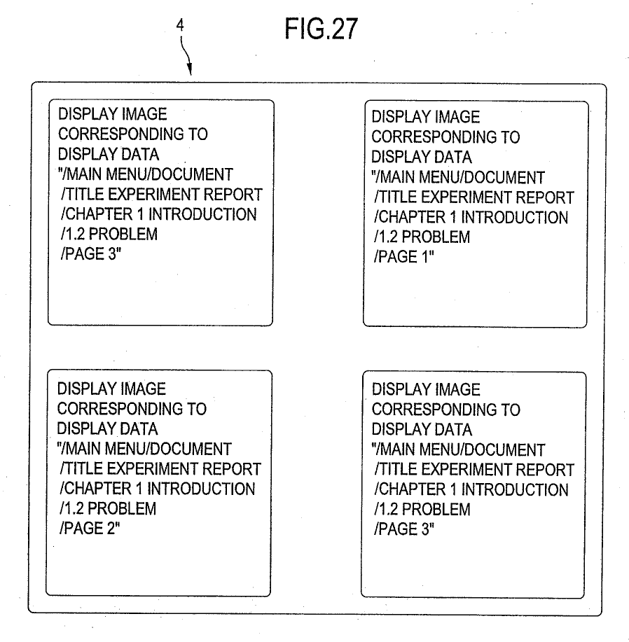

Further, while the CPU 2 displays the reminder images in ascending order of page numbers in S2504, the CPU 2 may display one reminder image including all reminder images corresponding to the display data for the all pages determined in S2504 as shown in FIG. 27.

While the invention has been described in detail with reference to the embodiments thereof, it would be apparent to those skilled in the art that various changes and modifications may be made therein without departing from the spirit of the invention.

For example, in the reminder data display process according to the first, second, and third embodiments described above, the continuous display time set in S702, S1402, and S2502 may be preset. Further, while the continuous display time was determined based on the second time measured by the timer 22, the continuous display time may be arbitrarily determined by the user. In this case, it is not necessary to provided the timer 22 with the browsing terminal 1.

Further, while the CPU 2 determines whether one of the operating keys 81-84 was operated in S105 and S108 of the main process in the first, second, and third embodiments described above, but the CPU 2 determines whether the display image was switched rather than whether one of the operating keys 81-84 was operated.

Further, in the first, second, and third embodiments described above, the supply of power to the browsing terminal 1 is started and stopped in S107 and S109 of the main process. The supply of power is started and stopped in S107 and S109 by controlling the system power switch 20 to connect and disconnect the system power supply 30 and the power supply block 99. Here, the system power switch 20 connects and disconnects to an electrical configuration that does not include the CPU 2 and the power supply controller 12, but the system power switch 20 should at least be able to switch between a state in which a drive voltage is not supplied to the electrophoretic display unit 4 and a state in which a drive voltage is supplied to the electrophoretic display unit 4.

While the browsing terminal 1 has the electrophoretic display unit 4 in the first, second, and third embodiments, but the present invention is not limited to an electrophoretic display device. For example, the browsing terminal may include a display unit having memory effect for maintaining display image even if supply of the power is interrupted. Hence, the display unit may employ electronic powder.

In the first, second, and third embodiments described above, the CPU 2 determines whether one of the operating keys 81-84 was operated in S105 and S108 of the main process. However, the CPU 2 may determine whether an event on the browsing terminal 1 other than an operation of the operating keys 81-84 has occurred and may store new operation history data based on this event. Examples of such events include a communication event from an external device, such as received e-mail, a received RSS, and received wireless data, as well as interrupt process.

Further, in S303 (FIG. 11), S603 (FIG. 13), S704 (FIG. 14), S1403 (FIG. 19), S1803 (FIG. 22) and S2504 (FIG. 24) of the reminder data display process, the CPU 2 redisplays the display image that was displayed just before the supply of power to the browsing terminal 1 was halted (current display image displayed in S107 of the main process). However, the CPU 2 may display the main menu displayed in the display screen 4-b shown in FIG. 12 in place of the current display image that was displayed in S107. Further, the CPU 2 may display the display image corresponding to a page number larger or smaller than the page number corresponding to the current display data for one page. By redisplaying the display image that was displayed in S107, the user can start to operate the browsing terminal 1 in the state that existed just before the supply of power was halted in S107. Hence, this method makes the browsing terminal 1 more user-friendly. However, since it is conceivable that the user may not start to operate the browsing terminal 1 in the state that existed just before the power supply was shut off in S107, the CPU 2 may display the main menu rather than redisplaying the display data.

In S111 of the main process described in the first, second, and third embodiments, the CPU 2 begins supplying power to the browsing terminal 1 and displays the reminder images on the electrophoretic display unit 4 based on an operation of one of the operating keys 81-84 in S108. However, the present invention is not limited to an operation of one of the operating keys 81-84. For example, when the browsing terminal 1 is provided with a power switch, power button, or the like for switching on and off the supply of power to the browsing terminal 1, the CPU 2 may perform the above process based on an operation on the power switch or power button.

What is claimed is:

1. A browsing terminal comprising:
a nonvolatile display unit that overwritably displays a first display image based on first display data when the nonvolatile display unit is set to a first mode, and maintains the first display image when the nonvolatile display unit is set to a second mode; and
a reminder data storing unit that stores reminder data, the remainder data including information about the first display image, and
wherein the nonvolatile display unit displays a remainder image based on the reminder data ahead of the first display image when the nonvolatile display unit is set to the first mode after the nonvolatile display unit was set to the second mode.

2. The browsing terminal according to claim 1, further comprising a display data storing unit that stores document data representing a document having a title and a plurality of chapters, the document data including a plurality of sets of page data, each set of page data corresponding to a page of the document and having a page number, each page belonging to one of the plurality of chapters, the page data including the first display data; and
wherein the reminder data storing unit stores the reminder data including the title, name of the chapter to which the first display data corresponds, and the page number to which the first display data corresponds.

3. The browsing terminal according to claim 1, further comprising:
a timer that measures a first time that has elapsed since the nonvolatile display unit was set to the second mode until the nonvolatile display unit is set to the first mode; and
a first determining unit that determines whether the first time is longer than or equal to a prescribed time, and
wherein the nonvolatile display unit displays the remainder image ahead of the first display image when the first determining unit determines that the first time is longer than or equal to the prescribed time and the nonvolatile display unit is set to the first mode after the nonvolatile display unit was set to the second mode.

4. The browsing terminal according to claim 1, further comprising:
a timer that measures a first time that has elapsed since the nonvolatile display unit was set to the second mode until the nonvolatile display unit is set to the first mode; and
a second determining unit that determines a display time for displaying the remind image on the nonvolatile display unit based on the first time, and
wherein the nonvolatile display unit has displayed the remainder image ahead of the first display image for the display time, when the nonvolatile display unit is set to the first mode after the nonvolatile display unit was set to the second mode.

5. The browsing terminal according to claim 1, further comprising:
a display data storing unit that stores a plurality of sets of display data including the first display data;
a management unit that manages the plurality of sets of display data in a hierarchical structure; and
a first hierarchical position determining unit that determines a first hierarchical position at which the first display data is managed by the management unit; and
wherein the reminder data storing unit stores the first hierarchical position as the reminder data.

6. The browsing terminal according to claim 5, wherein the hierarchical structure includes a plurality of folders, each of a plurality of folders having at least one of the display data and the folder;
wherein the browsing terminal further comprises a second hierarchical position determining unit that determines second hierarchical position that is higher than the first hierarchical position for one level;
wherein the reminder data storing unit stores first folder data and second folder data as the reminder data, the first folder data including at least one set of display data that is managed in the first hierarchical position and the folder that is managed in the first hierarchical position, the second folder data including at least one set of display data that is managed in the second hierarchical position and the folder that is managed in the second hierarchical position; and
wherein the nonvolatile display unit displays, as the reminder images, first reminder image representing the first folder data, and second reminder image representing the second folder data.

7. The browsing terminal according to claim 6, further comprising a third hierarchical position determining unit that determines third hierarchical position, the third position being higher than the second hierarchical position for one level;
wherein the reminder data storing unit further stores third folder data as the reminder data, the third folder data including the at least one folder and display data that is managed in the third hierarchical position; and
wherein the nonvolatile display unit displays, for each hierarchical position, the reminder image representing the folder data corresponding to the subject hierarchical position, the nonvolatile display unit displaying the reminder images in order of hierarchical position from highest to lowest.

8. The browsing terminal according to claim 6, further comprising an identification data generating unit that generates identification data for each hierarchical position, the identification data representing the first display data and folders in which the first display data is managed; and
wherein the nonvolatile display unit displays the reminder image and identification image based on both the reminder data and the identification data.

9. The browsing terminal according to claim 5, further comprising:
a timer that measures a first time that has elapsed since the nonvolatile display unit was set to the second mode before the nonvolatile display unit is set to the first mode; and
a third determining unit that determines number of hierarchical positions based on the first time,
wherein the reminder data storing unit stores, as the reminder data, at least one of the display data and the folder that is managed in the number of hierarchical positions corresponding to the number of hierarchical positions determined by the third determining unit, and
wherein the nonvolatile display unit displays, based on the reminder data, the number of reminder images corresponding to the number of hierarchical positions, each reminder image representing the display data and the folder that is managed in the subject hierarchical position.

10. The browsing terminal according to claim 1, further comprising:
a display history storing unit that stores a plurality of sets of display history records, the plurality of display history record representing second display images that were displayed by the nonvolatile display unit while the nonvolatile display unit has set to the first mode before the nonvolatile display unit was set to the second mode, each display history record being stored when the nonvolatile display unit displays the second image and being arranged in order of storing in the display history storing unit; and
a display data generating unit that generates at least one set of second display data based on the display history records, and
wherein the reminder data storing unit stores the at least one set of second display data as the reminder data.

11. The browsing terminal according to claim 10, further comprising:
a timer that measures a first time that has elapsed since the nonvolatile display unit was set to the second mode until the nonvolatile display unit is set to the first mode; and
a fourth determining unit that determines number of display history records based on the first time,
wherein the display data generating unit that generates the number of sets of second display data corresponding to the number of display history records,
wherein the reminder data storing unit further stores, as the reminder data, the number of sets of second display data corresponding to the number of display history records, and
wherein the nonvolatile display unit displays, as the reminder images, the number of second display images based on the number of sets of second display data.

12. The browsing terminal according to claim 10, wherein the nonvolatile display unit displays the number of second display images based on the number of second display data, in order of storing second display data chronologically from oldest to newest.

13. The browsing terminal according to claim 1, further comprising:
a page data storing unit that stores a plurality of sets of page data, each page data having a page number, the plurality of page data including the first display data; and
a page number storing unit that stores the page number of the first display data;
wherein the reminder data storing unit stores, as the reminder data, at least one set of page data having the page numbers smaller than the page number of the first display data.

14. The browsing terminal according to claim 13, further comprising:
a timer that measures a first time that has elapsed since the nonvolatile display unit was set to the second mode until the nonvolatile display unit is set to the first mode; and
a fourth determining unit that determines number of page data based on the first time,
wherein the reminder data storing unit stores, as the reminder data, the number of sets of page data corresponding to the number determined by the third determining unit, each set of page data having the page numbers smaller than the page number of the first display data, and
wherein the nonvolatile display unit displays the number of reminder images based on the number of sets of page data.

15. The browsing terminal according to claim 13, wherein the nonvolatile display unit displays the respective reminder images in order of ones page data having the page number from the smallest to largest.

16. A data processing method executed by the browsing terminal, the browsing terminal including a nonvolatile display unit that overwritably displays the first display image based when the nonvolatile display unit is set to a first mode and maintains the first display image the first display image when the nonvolatile display unit is set to a second mode, the data processing method comprising:
setting the nonvolatile display unit to the first mode;
storing a remainder data including information about the first display image;
displaying a remainder image based on reminder data, the remainder data including information about the first display image; and
displaying the first display image.

17. A computer-readable recording medium that stores a data processing program executed by the browsing terminal, the browsing terminal including a nonvolatile display unit that overwritably displays the first display image based when the nonvolatile display unit is set to a first mode and maintains the first display image the first display image when the nonvolatile display unit is set to a second mode, the data processing program comprising instructions for:
setting the nonvolatile display unit to the first mode;
storing a remainder data including information about the first display image;
displaying a remainder image based on reminder data, the remainder data including information about the first display image; and
displaying the first display image.
